(19) United States
(12) Patent Application Publication
(10) Pub. No.: US 2015/0059471 A1
(43) Pub. Date: Mar. 5, 2015

(54) Sensing

(71) Applicant: Nokia Corporation, Espoo, FL (US)

(72) Inventors: Samiul HAQUE, Chesterton (GB); Stefano Marco Borini, Cambridge (GB); Richard White, Huntingdon (GB)

(73) Assignee: Nokia Corporation

(21) Appl. No.: 14/471,196

(22) Filed: Aug. 28, 2014

(30) Foreign Application Priority Data
Aug. 28, 2013 (GB) 1315249.1

(51) Int. Cl. G01N 27/12; G01N 19/10

(52) U.S. Cl. CPC G01N 27/121; G01N 19/10
USPC 73/335.05; 73/29.02; 73/335.02

(57) ABSTRACT

An apparatus including a first sensor including a sensing material that is sensitive to a first parameter and a second parameter, wherein sensitivity to the first parameter changes sensitivity to the second parameter. The sensitivity of the first sensor to one of the first and the second parameters may be controlled by maintaining, as a constant, the other of the first and the second parameters. The apparatus may include a second sensor sensitive to at least one of the first parameter and the second parameter. The first parameter may be deformation and the second parameter may be a concentration of a gaseous analyte such as, for example, humidity. The second sensor may include the sensing material that is sensitive to the first parameter and the second parameter.

### TECHNOLOGICAL FIELD

Embodiments of the present invention relate to an apparatus and a method. In particular, they relate to sensing using the apparatus and method.

### BACKGROUND

In order to process data representing a real-world parameter, it is necessary to sense that parameter and covert the sensed value to data.

There is therefore a need for improved sensors.

### BRIEF SUMMARY

According to various, but not necessarily all, embodiments of the invention there is provided an apparatus comprising: a first sensor comprising a sensing material that is sensitive to a first parameter and a second parameter, wherein sensitivity to the first parameter changes sensitivity to the second parameter, wherein the first parameter is deformation and the second parameter is concentration of a gaseous analyte; and a second sensor sensitive to at least one of the first parameter and the second parameter.

According to various, but not necessarily all, embodiments of the invention there is provided a method comprising: processing an output from a first sensor comprising a sensing material that is sensitive to a first parameter and a second parameter, wherein sensitivity to the first parameter changes sensitivity to the second parameter, wherein the first parameter is deformation and the second parameter is concentration of a gaseous analyte; and processing an output from a second sensor sensitive to at least one of the first parameter and the second parameter.

According to various, but not necessarily all, embodiments of the invention there is provided an apparatus comprising: at least one processor; and at least one memory including computer program code the at least one memory and the computer program code configured to, with the at least one processor, cause the apparatus at least to perform:

processing an output from a first sensor comprising a sensing material that is sensitive to a first parameter and a second parameter, wherein sensitivity to the first parameter changes sensitivity to the second parameter, wherein the first parameter is deformation and the second parameter is concentration of a gaseous analyte; and

processing an output from a second sensor sensitive to at least one of the first parameter and the second parameter.

According to various, but not necessarily all, embodiments of the invention there is provided an apparatus comprising: a first sensor comprising a sensing material that is sensitive to a first parameter and a second parameter, wherein sensitivity to the first parameter changes sensitivity to the second parameter; and wherein a sensitivity of the first sensor to one of the first and the second parameter is controlled by maintaining, as a constant, the other of the first and the second parameters.

According to various, but not necessarily all, embodiments of the invention there is provided a method comprising: processing an output from a first sensor comprising a sensing material that is sensitive to a first parameter and a second parameter, wherein sensitivity to the first parameter changes sensitivity to the second parameter; wherein a sensitivity of the first sensor to one of the first and the second parameter is controlled by maintaining, as a constant, the other of the first and the second parameters.

### BRIEF DESCRIPTION

For a better understanding of various examples that are useful for understanding the brief description, reference will now be made by way of example only to the accompanying drawings in which:

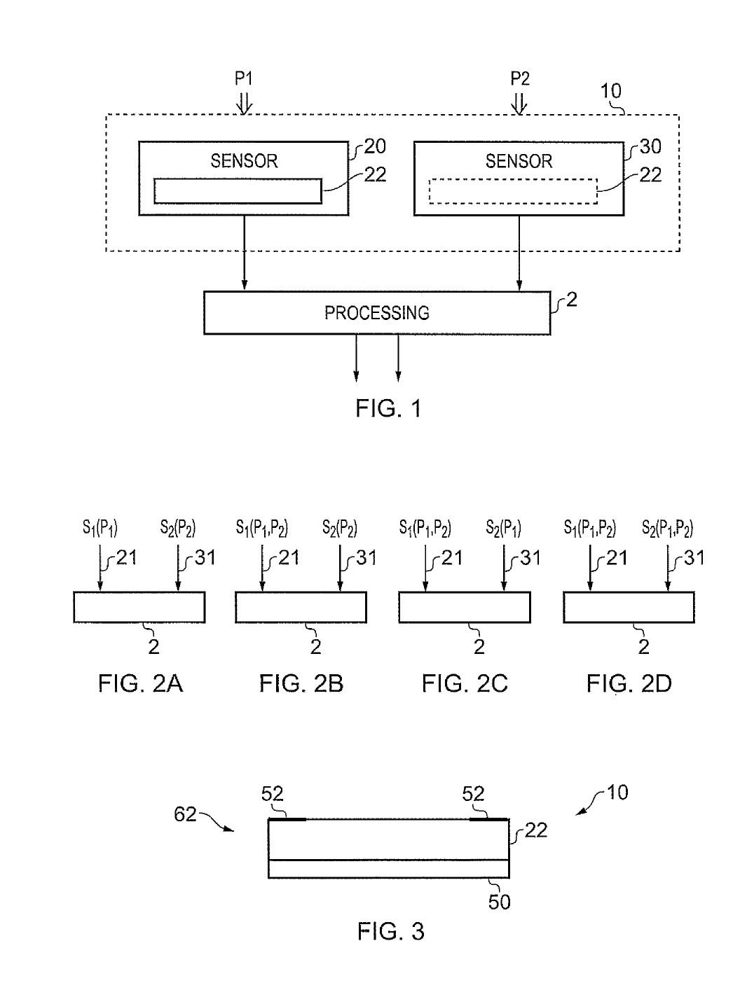

FIG. 1 illustrates an example of an apparatus configured to detect a first parameter p1 and/or a second parameter p2;

FIGS. 2A to 2D illustrate examples of different outputs from the apparatus to processing circuitry;

FIG. 3 illustrates an example of an apparatus comprising one or more sensors;

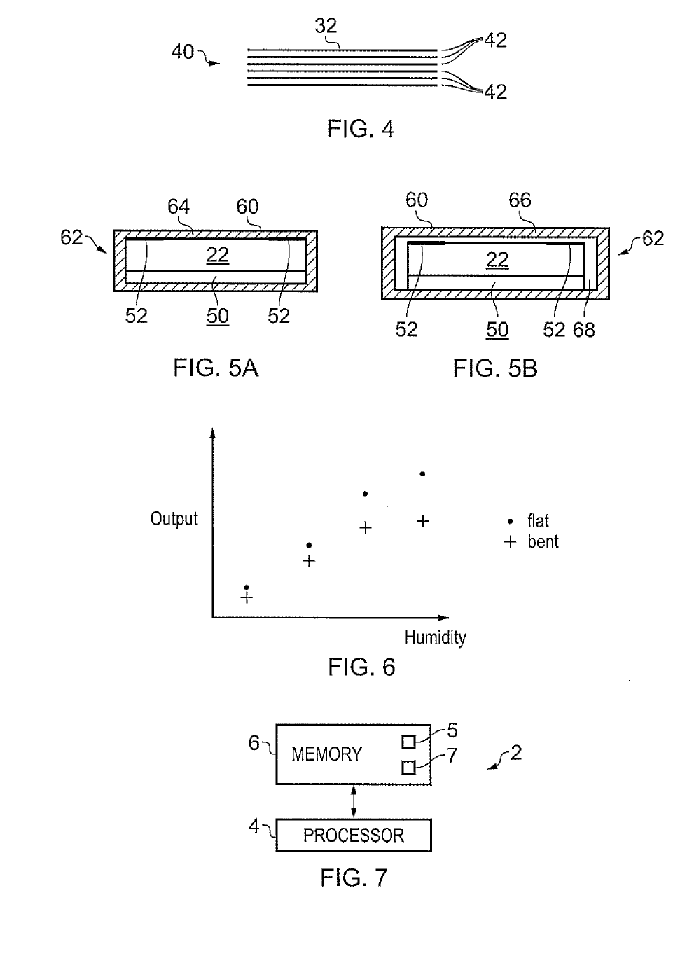

FIG. 4 illustrates a cross-section of an example of the sensing material in the apparatus;

FIGS. 5A and 5B illustrate examples where a sensitivity of the first sensor to one of the first and the second parameters is controlled by maintaining, as a constant, the other of the first and the second parameters;

FIG. 6 plots variation of output from the apparatus with deformation and with concentration of gaseous. analyte;

FIG. 7 illustrates an example of processing circuitry comprising a processor and a memory; and

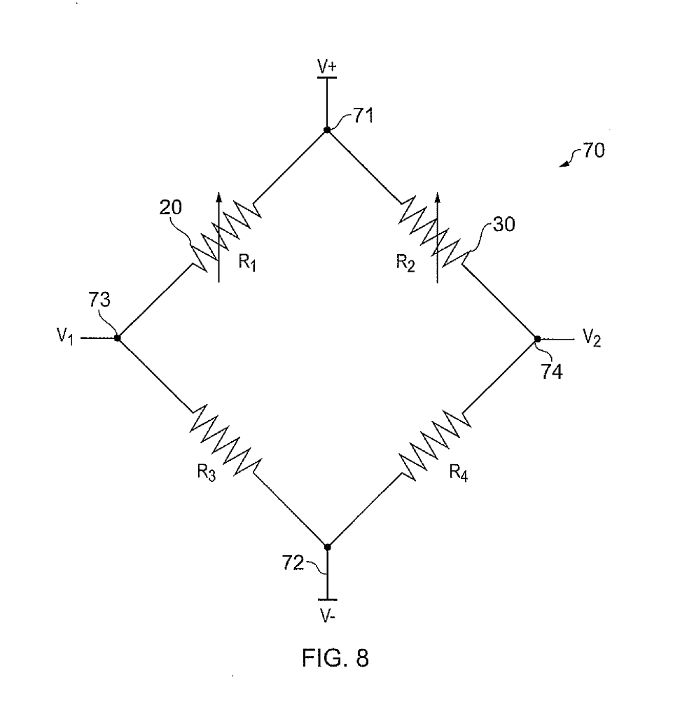

FIG. 8 illustrates an apparatus comprising temperature compensation circuitry.

### DETAILED DESCRIPTION

FIG. 1 illustrates an example of an apparatus 10. The apparatus 10 is configured to detect a first parameter p1 and/or a second parameter p2, and, may be referred to as a sensor apparatus 10 (when not is use) and a sensing apparatus 10 (when in use).

The apparatus 10 may be part of a larger apparatus comprising processing circuitry 2.

The apparatus 10 comprises a first sensor 20 and a second sensor 30.

The first sensor 20 comprises a sensing material 22 that is sensitive to the first parameter p1 and the second parameter (p2). The sensitivity of the sensing material 22 to the first parameter p1 changes a sensitivity of the sensing material 22 to the second parameter.

The second sensor 30 is sensitive to at least one of the first parameter p1 and the second parameter p2.

The sensitivity of the first sensor 20 to the first parameter p1 is different to a sensitivity of the second sensor 30 to the first parameter p1 and/or the sensitivity of the first sensor 20 to the second parameter p2 is different to a sensitivity of the second sensor 30 to the second parameter p2.

In some examples but not necessarily all examples, the first parameter p1 may be deformation (D) of the apparatus 10 and the second parameter p2 may be a concentration of a gaseous analyte at the apparatus 10.

The gaseous analyte may be water. The second parameter p2 may then be relative humidity (RH).

The apparatus 10 may be used with other gaseous analytes such, for example, NH₃, NO₂, Cl₂ as well as organic solvents including methanol and ethanol.

The deformation (D) may, for example, be a stretching deformation and/or a bending deformation and/or a twisting deformation.

In some examples but not necessarily all examples, the second sensor 30 may comprise the sensing material 22 that is sensitive to the first parameter p1 and the second parameter p2.

FIG. 6 illustrates an example of how a sensitivity of the sensing material 22 may vary with deformation and/or concentration of a gaseous analyte (relative humidity in this example). The y-axis represents sensor output value and the x-axis represents concentration of the gaseous analyte (relative humidity). A first series of plots is made in the figure mapping measured output against variable relative humidity, when the sensing material 22 is flat. A second series of plots is made in the figure mapping measured output against variable relative humidity, when the sensing material 22 is deformed (bent).

It is apparent that the output response of sensing material 22 is dependent upon both the relative humidity at the sensing material 22 and the deformation of the sensing material 22. The variation of the output to humidity (sensitivity to humidity) changes when the sensing material 22 is deformed. The variation of the output to deformation (sensitivity to deformation) changes when the sensing material 22 is exposed to different relative humidity.

Similar plots may be obtained for other gaseous analytes, such as those described previously.

FIG. 1 also illustrates processing circuitry 2. The processing circuitry 2 is configured to process an output 21 from the first sensor 20 and process an output 31 from the second sensor 30 and determine a value for the first parameter p1 and/or a value for the second parameter p2.

The processing circuitry 22 may use the output 21 from the first sensor 20 and the output 31 from the second sensor 30 to look-up values for the first parameter p1 and the second parameter p2 from a database.

FIG. 7 illustrates one example of processing circuitry 2 comprising a processor 4 and a memory 6.

The processor 4 is configured to read from and write to the memory 6. The processor 4 may also comprise an output interface via which data and/or commands are output by the processor 4 and an input interface via which data and/or commands are input to the processor 4.

The memory 6 stores a computer program 5 comprising computer program instructions (computer program code) that controls the operation of the processing circuitry 2 when loaded into the processor 4. The computer program instructions, of the computer program 5, provide the logic and routines that enables the apparatus to perform the one or more of the methods illustrated in FIGS. 2A to 2D. The processor 4 by reading the memory 6 is able to load and execute the computer program 5.

The apparatus therefore comprises: at least one processor 4; and at least one memory 5 including computer program code 5 the at least one memory 6 and the computer program code 5 configured to, with the at least one processor 4, cause the apparatus 10 at least to perform:

processing an output 21 from a first sensor 20 comprising a sensing material 22 that is sensitive to a first parameter p1 and a second parameter p2, wherein sensitivity to the first parameter p1 changes sensitivity to the second parameter p2; and

processing an output 22 from a second sensor 30 sensitive to at least one of the first parameter p1 and the second parameter p2.

This processing determines a value for the first parameter p1 and/or a value for the second parameter p2.

The processing may use the output 21 from the first sensor 20 and the output 31 from the second sensor 30 to look-up values for the first parameter p1 and/or the second parameter p2 from a database 7 stored in the memory 6 or elsewhere

In some examples but not necessarily all examples, a sensitivity of the first sensor 20 to the first parameter p1 is different to a sensitivity of the second sensor 30 to the first parameter p1.

In some examples but not necessarily all examples, the first parameter p1 is deformation and the second parameter p2 is concentration of a gaseous analyte.

In some examples but not necessarily all examples, the second sensor 20 may comprise the sensing material 22 that is sensitive to the first parameter p1 and the second parameter p2.

FIGS. 2A to 2D illustrates examples of different outputs 21, 31 from the apparatus 10 to the processing circuitry 2.

In each of these examples, for a range of values of the second parameter p2, a sensitivity of the first sensor 20 to the first parameter p1 is different to a sensitivity of the second sensor 30 to the first parameter p1 and/or, for a range of values of the first parameter, a sensitivity of the first sensor 20 to the second parameter p2 is different to a sensitivity of the second sensor 30 to the second parameter p2.

This difference in sensitivity produces a differential input to the processing circuitry 22, comprised of the pair of outputs 21, 31 from the first and second sensors 20, 30. The differential input is in respect of the first parameter p1 and/or the second parameter p2.

In FIG. 2A, the first sensor 20 is configured to be sensitive to one of the first and second parameters but not the other one of the first and second parameters. The second sensor 30 is configured to be sensitive to the other of the first and second parameters but not the one of the first and second parameters.

The output s1 from the first sensor 20 is therefore, in this example, dependent upon only the first parameter p1. The output s2 from the second sensor 30 is therefore, in this example, dependent upon only the second parameter p2.

In FIG. 2B and FIG. 2C, the first sensor 20 is configured to be sensitive to both of the first and second parameters p1, p2 and the second sensor 30 is configured to be sensitive to only one of the first and second parameters p1, p2.

In the example of FIG. 2B, the output s1 from the first sensor 20 is dependent upon the first parameter p1 and the second parameter p2. The output s2 from the second sensor 30 is dependent upon only the second parameter p2.

In the example of FIG. 2C, the output s1 from the first sensor 20 is dependent upon the first parameter p1 and the second parameter p2. The output s2 from the second sensor 30 is dependent upon only the first parameter p1.

In FIG. 2D, the first sensor 20 is configured to be sensitive to both of the first and second parameters p1, p2 and the second sensor 30 is configured to be sensitive to both the first and second parameters p1, p2 but in a manner different to the first sensor 20.

FIG. 3 illustrates an example of an apparatus 10 comprising one or more sensors 62. For clarity, only a single sensor 62 is illustrated. This may be the first sensor 20 or the second sensor 30.

The sensor 62 comprises sensing material 22 supported by a flexible substrate 50. A pair of electrodes 52 are electrically connected to the sensing material 22.

The flexible substrate 50 may be formed from polyethylene polymer such as for example polyethylene napthalate (PEN) or polyethylene terephthalate (PET) or flexible glass.

The sensing material 22, may be formed by drop cast, spraying, spin coating, ink jet printing or screen printing.

The electrodes 52 may be positioned on an upper surface of the sensing material 22 such that the sensing material 22 is positioned between the electrodes 52 and the flexible substrate 50.

Alternatively, electrodes 52 may be positioned on an upper surface of the flexible substrate such that the electrodes 52 are positioned between the sensing material 22 and the flexible substrate 50. The electrodes 52 may be deposited on the substrate 50 (e.g. by screen printing or inkjet printing), followed by deposition of the sensing material 22 on top.

The electrodes 52 may be silver (Ag) printed electrodes.

The sensing material 22 is sensitive to the first parameter p1 and the second parameter (p2). The sensitivity of the sensing material 22 to the first parameter p1 changes a sensitivity of the sensing material 22 to the second parameter.

In this example the first parameter p1 is deformation (D) of the apparatus 10 and the second parameter is concentration of a gaseous analyte at the apparatus 10.

As illustrated in FIG. 4, in some but not necessarily all examples, the sensing material 22 may comprise a stack 40 of two-dimensional layers 42 of the same material. Each two-dimensional layer 42 has a thickness less than 100 nm or 1000 nm. The separation between stacked 2D layers 42 is sufficient to enable the diffusion of the gaseous analyte between the 2D layers 42.

Examples of suitable sensing material 22 include graphene, graphene oxide, reduced graphene oxide, functionalised graphene, boron nitride and transition metal dichalogenides such as, for example, disulphides such as, for example, molybdenum disulfide (MoS₂).

Each sensing material 22 is optimal for different gaseous analytes.

Molybdenum disulfide (MoS₂) may be used to sense triethylamine.

Graphene may be used to sense nitrogen dioxide (NO₂), ammonia (NH₃) or carbon dioxide (CO₂).

Graphene oxide may be used to sense humidity.

the sensing material 22 is graphene oxide.

In some but not necessarily all examples the sensing material 22 comprises functional groups—such as hydroxyl, epoxy, carboxyl groups—that can provide hydrogen ions (protons) in the presence of water or other gaseous analytes. This decreases an electrical resistance of the sensing material 22 in the presence of water vapour (humidity) or other gaseous analytes.

The sensing material 22 may be strongly electropositive or strongly electronegative with respect to the gaseous analyte. The gaseous analyte will then either donate electrons (sensing material 22 is electronegative) or withdraw electrons (sensing material 22 is electronegative), causing a change in electronic properties such as, for example, electrical conductivity.

In some but not necessarily all examples, the sensitivity of the sensing material 22 to the gaseous analyte may be selectively controlled by controlling the number of layers 42 in the stack 40. For example, a thin film of sensing material 22 may be less than 1000 nm and sensitive to humidity, whereas a thick film of sensing material 22 may be greater than 2000 nm and more sensitive to humidity.

In some but not necessarily all examples, the sensitivity of the sensing material 22 to the gaseous analyte and/or deformation may be selectively controlled by using different sensing material 22. For example, the first sensor 20 may use graphene oxide as the sensing material 22 and the second sensor 30 may use graphene oxide as the sensing material 22, however the sensitivity of the first and/or second sensor may be differentially controlled by using different species of sensing material 22 or different variants of the same species of sensing material 22 in the first and second sensors. For example, the sensing material 22 of one of the first and second sensors may comprise one or more functional groups absent from the sensing material 22 of the other one of the first and second sensors.

FIGS. 5A and 5B illustrate examples where a sensitivity of a sensor 62 to one of the first and the second parameters p1, p2 is controlled by maintaining, as a constant, the other of the first and the second parameters. Additional structure 60 is provided at the sensor 62 to maintain, as a constant, one of the first and second parameters. The additional structure 60 blocks changes associated with that parameter. For clarity, only a single sensor 62 is illustrated. This may be the first sensor 20 or the second sensor 30.

In the example of FIG. 5A, a sensitivity of a sensor 62 to the first parameter (Deformation of the sensor 62) is selectively controlled whereas a sensitivity of the sensor 62 to the second parameter (Concentration of gaseous analyte at the sensor 62) is not selectively controlled. This is achieved by maintaining, as a constant, the deformation of the sensor 62 by physically attaching a non-flexible coating 64 that provides a physical structure that restrains movement of the sensing material 22 at a fixed deformation or at no deformation. The deformation (or no deformation) is therefore constant and locked-in by the stiff coating 64.

In some but not necessarily all embodiments, the coating 64 may be permeable to allow the gaseous analyte (e.g. water vapour) to ingress and reach the sensing material 22.

In the example of FIG. 5B, a sensitivity of a sensor 62 to the second parameter (concentration of gaseous analyte at the sensor 62) is selectively controlled whereas a sensitivity of the sensor 62 to the second parameter (Deformation of the sensor 62) is not selectively controlled. This is achieved by maintaining, as a constant, the concentration of the gaseous analyte at the sensor 62 by sealing the sensor 62 using a coating 66 that provides a physical structure that seals the sensing material 22 at a fixed concentration of the gaseous analyte (e.g. fixed humidity) and prevents ingress or egress of the gaseous analyte. The concentration of the gaseous analyte is therefore constant and locked-in by the impermeable coating 66.

In some but not necessarily all embodiments, the coating 64 may be flexible and unattached to the sensing material 22 so that there is a gap or void 68 between the impermeable coating 66 and the sensing material 22. This allows deformation of the sensing material 22.

FIG. 8 illustrates an apparatus 10 comprising temperature compensation circuitry 70. The temperature compensation circuitry 70 comprises a Wheatstone bridge arrangement. In a Wheatstone bridge a first series combination of resistors R1, R3 is connected between a first node 71 and a second node 72 and a second series combination of resistors R2, R4 is connected between the first node 71 and the second node 72 in electrical parallel to the first series combination of resistors.

The resistor R1 in the first series combination of resistors is connected between the first node 71 and a third node 73. The resistor R3 in the first series combination of resistors is connected between the third node 73 and the second node 72.

The resistor R2 in the second series combination of resistors is connected between the first node 71 and a fourth node 74. The resistor R4 in the second series combination of resistors is connected between the fourth node 74 and the second node 72.

An input voltage Vin is applied between the first node 71 and the second node.

An output voltage Vout is taken between the third node 73 and the fourth node 74.

When the bridge is balanced, R1/R3=R2/R4.

One or more of the resistor R1, R2, R3, R4 may be provided by a first sensor 20.

In some examples but not necessarily all examples, none, one or more of the remaining resistor R1, R2, R3, R4 may be provided by a second sensor 30.

The presence of the first and/or second parameter results in a change in a resistance and an unbalancing of the bridge.

The use of a first sensor 20 as resistor R1 and the use of the second sensor 30 as the resistor R2 may provide temperature compensation.

The configuration of the Wheatstone bridges (half or full bridge) could be implemented for one sensor for temperature compensation or separately (individually) for sensor elements where the sensors have a different (permeable, non-permeable) sensor configuration. The compensation of temperature is applicable while the devices are deformed.

A sensor when deformed may require temperature compensation. In one particular configuration when the material, for example graphene oxide, is coated with a permeable coating and a similar device has an impermeable coating then both sensors may require temperature compensation Wheatstone bridge configuration.

If one device is used on its own (that is individually/separately) then temperature compensation Wheatstone bridge configuration may also be required.

For temperature compensation a sensor may require half or full bridge circuit compensation.

Referring back to FIG. 7, the computer program 5 may arrive at the processing circuitry 2 via any suitable delivery mechanism. The delivery mechanism may be, for example, a non-transitory computer-readable storage medium, a computer program product, a memory device, a record medium such as a compact disc read-only memory (CD-ROM) or digital versatile disc (DVD), an article of manufacture that tangibly embodies the computer program 5. The delivery mechanism may be a signal configured to reliably transfer the computer program 5. In some examples, the processing circuitry 2 may propagate or transmit the computer program 5 as a computer data signal.

Although the memory 6 is illustrated as a single component it may be implemented as one or more separate components some or all of which may be integrated/removable and/or may provide permanent/semi-permanent/ dynamic/cached storage.

Although the processor 4 is illustrated as a single component it may be implemented as one or more separate components some or all of which may be integrated/removable.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single /multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:

(a) hardware-only circuit implementations (such as implementations in only analog and/or digital circuitry) and

(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.”

As used here ‘module’ refers to a unit or apparatus that excludes certain parts/components that would be added by an end manufacturer or a user. The apparatus 10 may be a module for incorporation into another apparatus.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this brief description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus comprising:
a first sensor comprising a sensing material that is sensitive to a first parameter and a second parameter, wherein sensitivity to the first parameter changes sensitivity to the second parameter, wherein the first parameter is deformation and the second parameter is concentration of a gaseous analyte; and
a second sensor sensitive to at least one of the first parameter and the second parameter.

2. An apparatus as claimed in claim 1, wherein the second parameter is humidity.

3. An apparatus as claimed in claim 1, wherein the second sensor comprises the sensing material that is sensitive to the first parameter and the second parameter.

4. An apparatus comprising:
a first sensor comprising a sensing material that is sensitive to a first parameter and a second parameter, wherein sensitivity to the first parameter changes sensitivity to the second parameter;
a second sensor comprising the sensing material that is sensitive to the first parameter and the second parameter,
wherein a sensitivity of the first sensor to the first parameter is different to a sensitivity of the second sensor to the first parameter.

5. An apparatus as claimed in claim 4, wherein the first parameter is deformation and the second parameter is concentration of a gaseous analyte.

6. An apparatus as claimed in claim 4, wherein the first parameter is humidity.

7. An apparatus as claimed in claim 1, wherein the sensing material is selected from the group comprising: graphene oxide, graphene, functionalised graphene, boron nitride, transition metal dichalcogenides.

8. An apparatus as claimed in claim 1, wherein the sensing material comprises a stack of two-dimensional layers of the same material.

9. (canceled)

10. An apparatus as claimed in claim 1, wherein, for a range of values of the second parameter, a sensitivity of the first sensor to the first parameter is different to a sensitivity of the second sensor to the first parameter and wherein, for a range of values of the first parameter, a sensitivity of the first sensor to the second parameter is different to a sensitivity of the second sensor to the second parameter.

11. (canceled)

12. (canceled)

13. (canceled)

14. (canceled)

15. (canceled)

16. (canceled)

17. (canceled)

18. (canceled)

19. (canceled)

20. An apparatus as claimed in claim 1, wherein a sensitivity of the first and/or second sensor is selectively controlled by: selectively suppressing sensitivity to deformation but not gaseous analyte ingress by using a physically attached coating that is permeable; or
selectively suppressing sensitivity to gaseous analyte ingress but not deformation by using an unattached impermeable coating; or
maintaining a constant gaseous analyte concentration using a seal; or
maintaining a constant deformation.

21. (canceled)

22. (canceled)

23. (canceled)

24. An apparatus as claimed in claim 1, wherein a sensitivity of the first and/or second sensor is differentially controlled by using a different thickness of sensing material in the first and second sensors or using different sensing material in the first and second sensors.

25. (canceled)

26. An apparatus as claimed in claim 1, wherein the sensing material in the first and second sensors both comprises graphene oxide but the material of one of the first and second sensors comprises one or more functional groups absent from the material of the other one of the first and second sensors.

27. An apparatus as claimed in claim 1, comprising a flexible substrate.

28. An apparatus as claimed in claim 1, comprising temperature compensation circuitry.

29. (canceled)

30. A method comprising:
processing an output from a first sensor comprising a sensing material that is sensitive to a first parameter and a second parameter, wherein sensitivity to the first parameter changes sensitivity to the second parameter, wherein the first parameter is deformation and the second parameter is concentration of a gaseous analyte; and
processing an output from a second sensor sensitive to at least one of the first parameter and the second parameter.

31. A method as claimed in claim 30, wherein the second sensor comprises the sensing material that is sensitive to the first parameter and the second parameter.

32. A method comprising:
processing output from a first sensor comprising a sensing material that is sensitive to a first parameter and a second parameter, wherein sensitivity to the first parameter changes sensitivity to the second parameter;
processing output from a second sensor comprising the sensing material that is sensitive to the first parameter and the second parameter,
wherein a sensitivity of the first sensor to the first parameter is different to a sensitivity of the second sensor to the first parameter.

33. A method as claimed in claim 32, wherein the first parameter is deformation and the second parameter is concentration of a gaseous analyte.

34. A method as claimed in claim 30, comprising: processing the output from the first sensor and the output from the second sensor to determine a value for the first parameter and a value for the second parameter.

35. (canceled)

36. (canceled)

37. (canceled)

38. An apparatus comprising:
a first sensor comprising a sensing material that is sensitive to a first parameter and a second parameter, wherein sensitivity to the first parameter changes sensitivity to the second parameter; and
wherein a sensitivity of the first sensor to one of the first and the second parameter is controlled by maintaining, as a constant, the other of the first and the second parameters.

39. An apparatus as claimed in claim 38, wherein the other of the first and second parameters is maintained by:
providing additional structure to the sensor; or
providing additional structure to block changes associated with the other of the first and second parameters; or
using a physically attached coating that is permeable; or
using an unattached impermeable coating; or
using a seal to maintain a constant gaseous analyte concentration; or
locking a constant deformation.

40. (canceled)

41. (canceled)

42. (canceled)

43. (canceled)

44. (canceled)

45. An apparatus as claimed in claim 38, comprising a second sensor comprising the sensing material that is sensitive to the first parameter and the second parameter.

46. A method comprising:
processing an output from a first sensor comprising a sensing material that is sensitive to a first parameter and a second parameter, wherein sensitivity to the first parameter changes sensitivity to the second parameter; wherein a sensitivity of the first sensor to one of the first and the second parameter is controlled by maintaining, as a constant, the other of the first and the second parameters.
